(19) United States
(12) Patent Application Publication
(10) Pub. No.: US 2011/0042533 A1
(43) Pub. Date: Feb. 24, 2011

(54) ENERGY ABSORBING TOOL LANYARD AND ATTACHMENT ASSEMBLY THEREFORE

(75) Inventor: Barry J. Austin, Houston, TX (US)

Correspondence Address: Polster, Lieder, Woodruff & Lucchesi, L.C., 12412 Powerscourt Dr. Suite 200, St. Louis, MO, 63131-3615, US

(73) Assignee: Reliance Industries, LLC, Wheat Ridge, CO (US)

(21) Appl. No.: 12/762,979

(22) Filed: Apr. 19, 2010

Related U.S. Application Data
(60) Provisional application No. 61/235,938, filed on Aug. 21, 2009.

(51) Int. Cl. F16M 13/02

(52) U.S. Cl. 248/222.14; 248/220.21

(57) ABSTRACT

An attachment assembly is provided to secure an object to a lanyard. The attachment assembly is capable of securing objects of different sizes and weights to the lanyard.

### CROSS REFERENCE TO RELATED APPLICATIONS

This application is the non-provisional of, and claims priority to, U.S. App. No. 61/235,938 filed Aug. 21, 2009 and which is incorporated herein by reference.

### BACKGROUND OF THE INVENTION

The invention relates generally to clamp assemblies used to secure a tool to a lanyard. In one aspect, the clamp assembly includes a band which allows for attachment of the clamp assembly to tools of varying sizes. In another aspect, the clamp assembly band allows for attachment to substantially heavy hand-tools.

Dropped objects (such as tools) are a concern at workplaces. Typically, workers below ongoing steel erection activities (other than hoisting) must wear head protection. If head protection is not worn, then work below steel erection activities is not permitted. The requirement for head protection is self-evident. Even a small or light tool can create a safety hazard if dropped. Current tool lanyards are designed for tools and equipment lighter than 10 pounds (˜4.5 kg). However, many tools can weigh more than 10 lbs. Hence, it would be desirable to provide tool lanyards that can accommodate heavier tools.

Further, the forces generated by a dropped tool can be extremely high. For example, a 25 lb (11.3 kg) tool when dropped 6 feet (1.8 m) on an 0.375″ wire rope can produce a peak force of 880 lbs (˜400 kg) at the anchor (or connection) point; and a 35 lb tool dropped 6.5° (˜2 m) can produce a peak force of 1587 lbs (˜720 kg) at the anchor point. Secondary resonance (i.e., rebound) peaks were almost 90% of the initial peak. Thus, it would be desirable to use a lanyard that provides for energy absorption and a reduction of rebound or secondary rebound.

Additionally, known attachment assemblies generally do not allow for attachment to tools of various shapes or to tools with different diameters or shapes. This requires the use of tool-specific attachments, which can be cumbersome. Hence, it would be desirable to provide an attachment assembly which can be used with a broad variety of tools.

### SUMMARY OF THE DISCLOSURE

Briefly stated, an attachment assembly is provided for securing an object to a lanyard. Generally, the attachment assembly comprises a stationary member a movable member, and an adjustment mechanism to move the movable member relative to the stationary member. One of the stationary and movable members defining an object or tool receiving surface. The tool receiving surface can be contoured, and can, for example define a curve or a notch (or both). A band having opposed ends and a mid-section is secured either the movable member or the stationary member to form a loop forwardly of the tool receiving surface.

In one illustrative embodiment, the tool receiving surface is on a forward surface of the stationary member and the band is secured to the movable member. In this embodiment, the stationary member comprises a body and the movable member comprises a bracket. The body is hollow and has a side surface, a first end defining the tool receiving surface or end, a send closed end opposite the tool receiving end. The bracket is received within the body and being movable axially relative to the body. The adjustment mechanism or means comprises a threaded adjusting shaft extending through the closed end of the body and engaging the bracket. The attachment assembly includes an attachment point for securing the attachment assembly to a lanyard. The tool receiving surface can define first and second contours which face different directions and which are differently shaped. For example, one of the contours can define a curve and the other can define a notch.

In accordance with one aspect of the attachment assembly, the bracket comprises an end wall and a pair of opposed arms extending forwardly from the end wall. The arms each have a pair of generally parallel slots, and the band is threaded through the slots to secure the band to the bracket. The bracket is sized relative to the body such that a gap is formed between outer surfaces of the bracket arms and an inner surface of the body. The band is threaded through the bracket arms slots, such that band extends along at least a portion of the outer surface of the bracket arms. The band has a width approximately equal to the width of the gap, such that a frictional engagement exists between the band and the body inner wall and between the band and the bracket arm.

In accordance with a further aspect of the attachment assembly, a pair of spaced apart pins extending across the body. The pins are generally parallel to the bracket arms and are spaced inwardly from the bracket arms. The band extends across inner surfaces of the pins, such that the loop has a generally tear-shaped appearance. The pins can be defined by arms of a U-bolt, in which case, the U-bolt defines the point of attachment.

In a second embodiment, the tool receiving surface is on a forward surface of the movable member and the band is secured to the stationary member. In this embodiment, the stationary member comprises a body and the movable member comprises a shoe. The body has side surfaces, an upper surface, a back surface, a bottom surface, and a front surface. A lever is pivotally mounted on the body to be movable between a locking position and a releasing position. The lever has a generally rounded bottom end with ridges extending at least partially across the bottom end. The lever is mounted to the body to define a gap between the lever and the body top surface through which the band passes. When the lever is in the locking position the ridges generally face the body top surface and engage the band. When the lever it is in the releasing position the ridges do not generally face the body top surface and do not engage the band. Further, the gap is increased in size slightly to enable the band to be moved through the gap. A biasing member biases the lever to the lever's locking position. In this embodiment, the attachment point comprises an ear extending from the body; the ear defining the attachment point.

In this embodiment, the adjustment mechanism or means comprises a threaded adjustment shaft which extends through the body to be received in the shoe. The adjustment shaft can be fixed to the shoe so that it can rotate relative to the shoe, but cannot move axially relative to the shoe. In this instance, the body includes a threaded opening through which the shaft extends. In accordance with one aspect of this embodiment, the shoe comprises a pair of opposed slots on opposite sides of the tool receiving surface; the band being threaded through the slots of the shoe.

### BRIEF DESCRIPTION OF THE DRAWINGS

FIG. 1 is a perspective, exploded view of an illustrative embodiment of an attachment assembly;

FIG. 2 is a side view of the attachment assembly with a tool held in place in the attachment assembly;

FIG. 3 is a cross-sectional view of the attachment assembly taken along line A-A of FIG. 2;

FIG. 4 is bottom plan view of an illustrative embodiment of the attachment assembly with the tool;

FIG. 5 is a perspective exploded view of a second illustrative embodiment of the attachment assembly;

FIG. 6 is a side elevational view of the attachment assembly of FIG. 5 in an assembled state;

FIG. 7 is a cross-sectional view of the attachment assembly taken along line 7-7 of FIG. 6

FIG. 8 is an end elevational view of the attachment assembly of FIG. 5 in an assembled state;

FIG. 9 is a cross-sectional view of the attachment assembly taken along line 9-9 of FIG. 8;

FIG. 10 is a bottom plan view of the attachment assembly of FIG. 5 in an assembled state;

FIGS. 11A-D show an alternative attachment assembly mounted on different tools;

FIG. 12 is an enlarged view of the attachment assembly of FIGS. 11A-D shown mounted on a hammer handle; and

FIG. 13 shows a fourth alternative attachment assembly for use with tools having, or which can have, holes formed therein.

Corresponding reference numbers indicate corresponding structures throughout the various figures.

### DETAILED DESCRIPTION

The following detailed description illustrates the invention by way of example and not by way of limitation. This description will clearly enable one skilled in the art to make and use the invention, and describes several embodiments, adaptations, variations, alternatives and uses of the invention, including what I presently believe is the best mode of carrying out the invention. Additionally, it is to be understood that the invention is not limited in its application to the details of construction and the arrangements of components set forth in the following description or illustrated in the drawings. The invention is capable of other embodiments and of being practiced or being carried out in various ways. Also, it is to be understood that the phraseology and terminology used herein is for the purpose of description and should not be regarded as limiting.

A first illustrative embodiment of an attachment assembly 10 which is used to connect a tool to a lanyard L is shown generally in FIGS. 1-4. The attachment assembly 10 a body 12. The body 12 comprises a hollow tube which is open at its opposite ends. The body 12 is illustratively shown to be generally rectangular in side elevation and generally square in top plan. The body 12 comprises a first pair of opposed walls 14 and a second pair of opposed walls 16. At a first, or tool engaging end, of the body 12, wall 14 is provided with a curved edge 14a and wall 16 is provided with a generally V-shaped cutout 16a. At the opposite, second, end of the body 12, the wall edges are generally flat. The walls 16 are each provided with a pair of opposed holes 18. Although not shown, similar pairs of holes could be provided in the opposed walls 14. The two shapes for the tool engaging end of the body 12 enable the attachment assembly 10 to be used with a broader variety of tools. For example, tools, such as screwdrivers, which have narrow diameter shafts, can be received across the walls 16 and be received in the V-shaped cutout 16a. On the other hand, tools, such as hammers, which have a wider handle, can be received across the walls 14 to be received on the curved edge 14a of the walls 14.

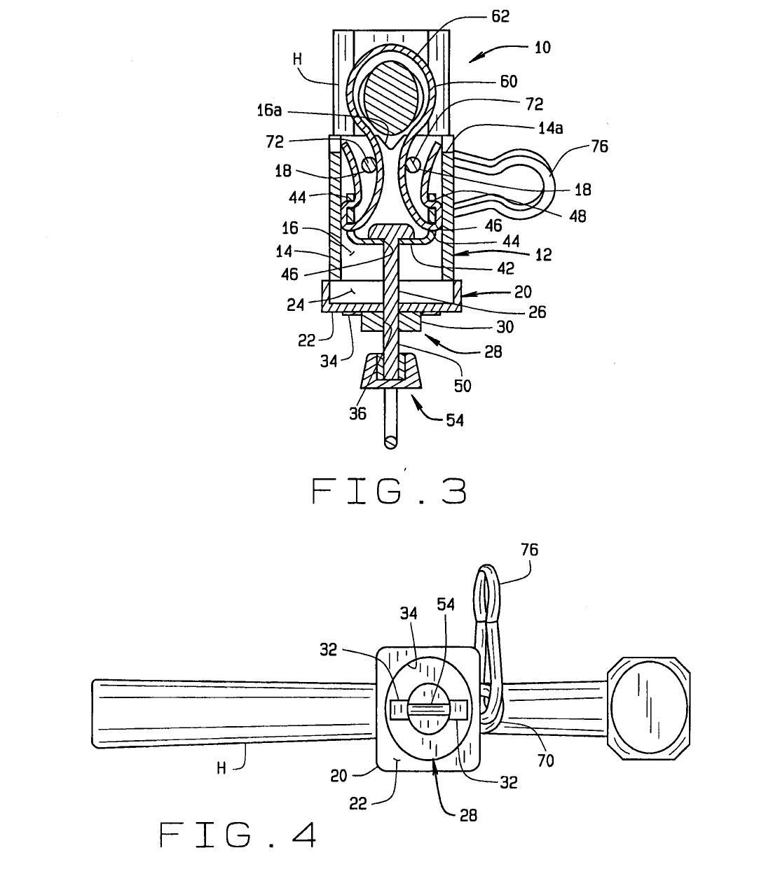

A cap 20 is received on the body 12 second end of the body. The cap 20 includes an end wall 22 and side walls 24. The end wall 22 and side walls 24 are sized and shaped, such that the cap 20 will snuggly fit over the end of the body 12. A aperture 26 is formed in the end wall. The aperture 26 is shown to be generally centered relative to the cap end wall 22. An end member 28 is received on the outer surface of the cap end wall 22. The end member 28 has a central post 30 (FIG. 3) with lugs (FIG. 4) extending radially from opposite sides of the post 30. A flange or base 34 surrounds the post 30. A hole 36 extends through the post 30 and is aligned with the aperture 26 in the cover end wall 22. Preferably, the hole 36 is internally threaded. Although the end member 28 is shown as a separate member, the end member 28 could be incorporated into the cap 20, such that the cap 20 and end member 28 form a one-piece element.

A bracket 40 is received in the body 12. The bracket 40 comprises an end wall 42 and opposed arms 44. The bracket 40 is sized such that it can be received in the body with the walls 44 adjacent either the body walls 14 or the body walls 16. The bracket 40 is sized such that when the bracket 40 is received in the body 12, there is a slight gap between bracket arms 44 and the body walls 12 or 14 (depending on the orientation of the bracket 40 in the body 12). The bracket end wall 42 is provided with an aperture 46 which is generally centered relative to the end wall 42. The aperture 46 is also aligned with the aperture 26 in the body cap end wall 22 and the hole 36 in the end member post 30. The bracket arms 44 include spaced apart slots 46, 48.

A threaded adjusting shaft 50 extends through the bracket opening 46, the cap end wall aperture 26, and the end member hole 36. The shaft 50 includes having a head 52 which is adjacent a top surface (with reference to FIG. 3) of the bracket end wall 42. A knob 54 is fixed to the end of the shaft 50 opposite the head 52. The knob 54 is fixed to the shaft 50, such that the shaft 50 can be rotated by rotation of the knob 54. As noted, the hole 36 in the end member post 30 is threaded. Thus, by rotating the shaft, the position of the bracket 40 in the body 12 can be altered. By rotating the shaft 30 in one direction, the bracket 40 can be brought closer to the cap 20, and by rotating the shaft 50 in the opposite direction, the bracket 40 can be moved away from the cap 20. Although the end member hole 36 is described to be threaded, the hole 46 in the bracket end wall 42 could be threaded instead (or the bracket end wall could otherwise engage the threads on the shaft 50). In this case, rotation of the shaft 50 will move the bracket along the shaft 50 toward or away from the body cap 20 (depending on the direction of rotation shaft 50. Additionally, although the shaft 50 is provided with a head 52, the head could be replaced with a cotter pin, lock ring or the like which will serve to prevent the bracket 40 from coming off the shaft 50. Hence, the head (or its replacement) operates as a stop or retainer.

A flexible strap or band 60 is threaded through the two slots 46, 48 on each of the bracket arms 44. As seen in FIG. 3, the strap extends through the lower slot 46 from the inside of the bracket, extends along the outer surface of the bracket arm 44, and then in inserted through the upper slot 48. As noted above, the bracket is sized to form a gap between the bracket arm and the inner surface of the body wall. This gap is approximately equal to the width of the band 60, such that the band 60 will be sandwiched between the bracket arm 44 and the inner surface of the body wall when the attachment assembly is assembled, as seen in FIG. 3. The band or strap extends from the tool receiving end of the body 12 to form a loop 62 though which a tool handle or tool shaft extends. The strap or band 60 can be made from a rubberized web or other similar flexible material which will also frictionally engage the bracket arms 44 and inner surfaces of the body wall 12. Further, the flexibility of the strap or band 60 allows for the strap to accommodate and engage irregularly shaped tool shafts, handles or the like.

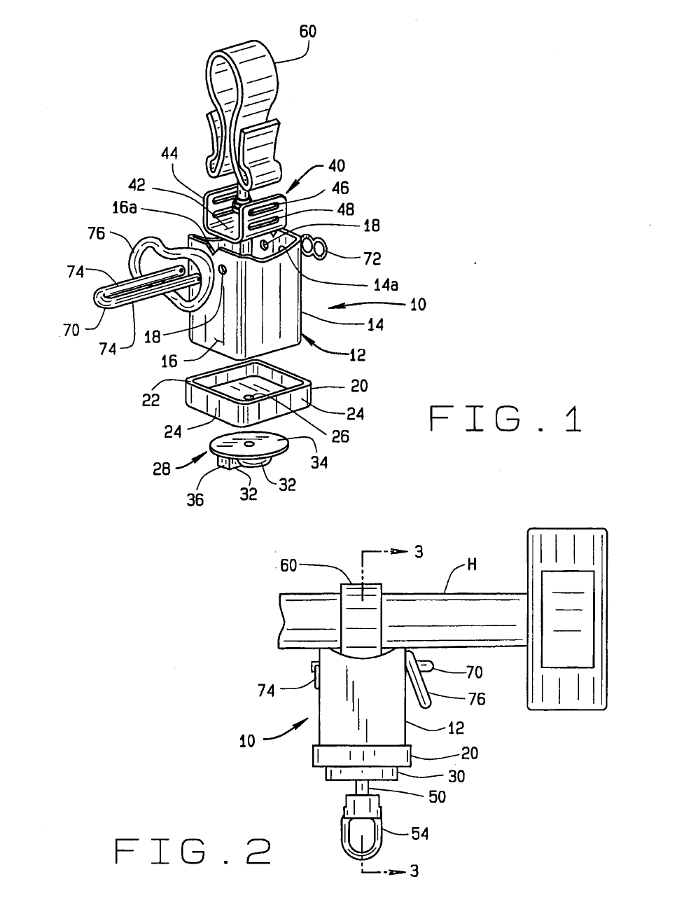

Finally, the attachment assembly includes a U-bolt 70 having U-bolt arms 72 which extend through the holes 18 of the body 12. The U-bolt 70 can be held in place by cotter-pins 72, lock rings, or the like which engage a portion of the U-bolt arms 74 extending out the opposite wall, as seen in FIG. 2. As seen in FIG. 3, the U-bolt arms 74 are generally parallel to the bracket arms 46 and are spaced inwardly relative to the bracket arms 46. The band 60 passes across the inner surfaces of the U-bolt arms 74. This pulls the opposite sides of the band 60 together, to give the loop 62 a more tear-shaped appearance, rather than a generally U-shaped appearance. By bringing the opposite sides of the band loop together, the band 60 engages a greater amount of the surface of the tool handle H. A clip 76, such as a carabiner clip, serves as an attachment point to attach the attachment assembly 10 to a lanyard. The U-bolt 70 could be replaced with pins or rods which extend across the body 12, to serve the same function as the U-bolt arms 74. This, however, would necessitate the addition of an attachment point on the body 12 for the clip 76, such that the body 12 can be secured to a lanyard.

In use, the shaft 50 is rotated to move the bracket 40 in the body so that the band loop will be large enough to pass the tool handle H through the loop 62. With the tool handle positioned relative to the loop 62, the shaft is rotated to draw the bracket 40 towards the cap 20 to thereby decrease the amount of the loop extending from the body 12, and to draw the band against the tool handle H. The handle will thus be secured between the edge of the body 12 and the band 60. Because the band 60 is flexible, and due to the tear-dropped shape of the band loop, the band will engage more than 180° of the handle surface, and will intimately contact the handle along the full extent of the engagement with the handle. Further, because the band has a high coefficient of friction, the handle will not be able to slide easily relative to the band. Additionally, the frictional engagement of the band 60 with the bracket and the body inner surface will further prevent the bracket 40 from moving relative to the body 12.

The clip 76 is preferably attached to a force attenuating lanyard. A preferred lanyard is available from Reliance Industries of Wheatridge, Colo. under Product No. 799955.

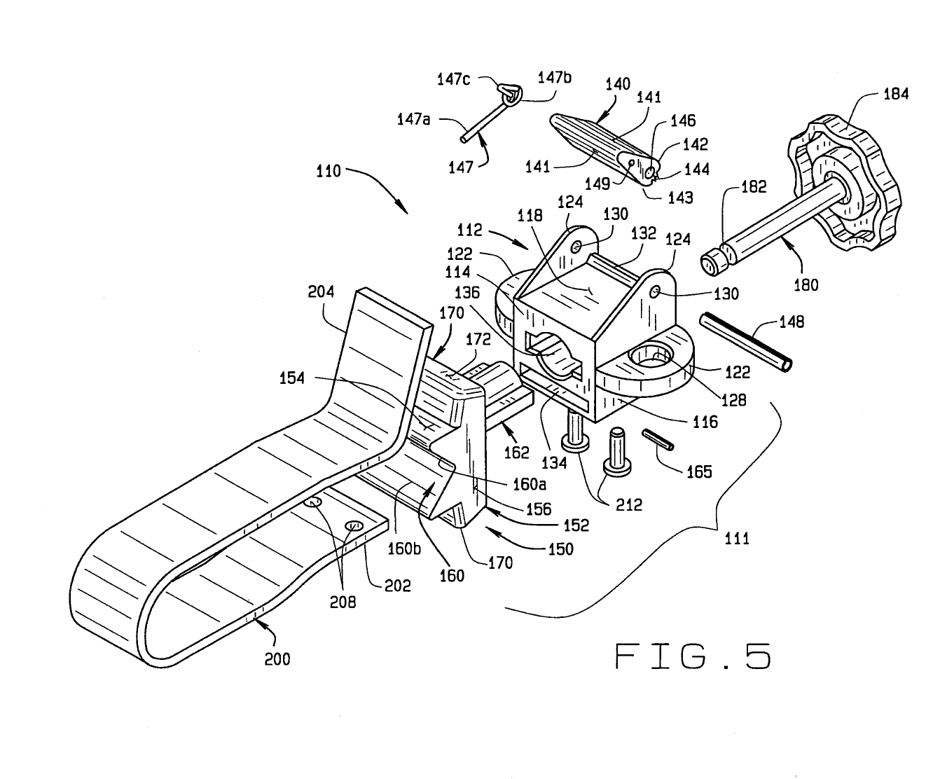

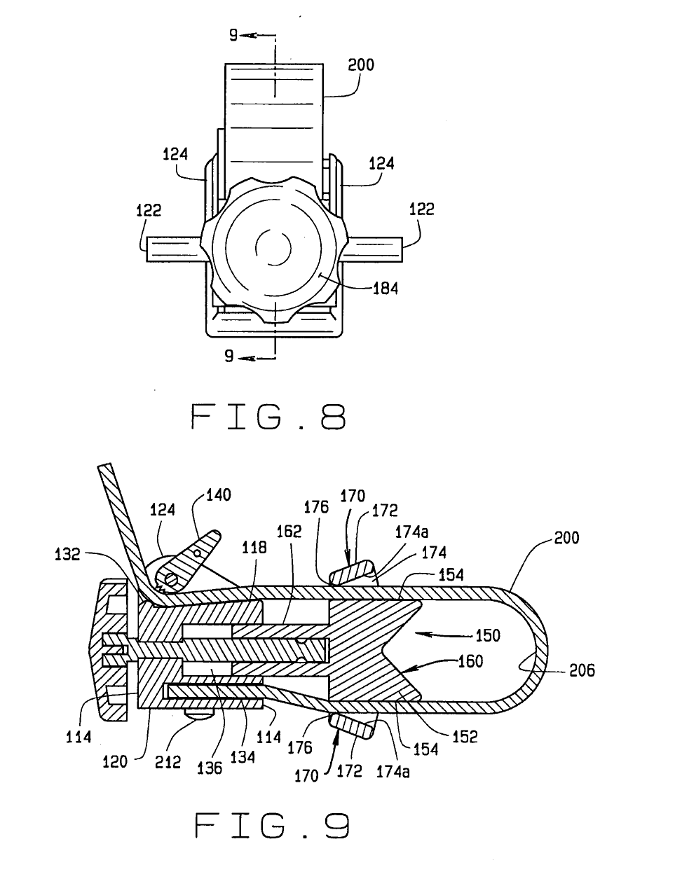

A second illustrative embodiment of an attachment assembly is shown in FIGS. 5-10. The attachment assembly 110 includes a body assembly 111 comprised of a block 112 and a tool receiving portion 150. The block 112 is shown to be generally square and has front and back surfaces 114, side surfaces 116, a top surface 118 and a bottom surface 120. Ears 122 extend outwardly from the side surfaces 116 and flanges 124 extend upwardly from opposite sides of the top surface 118. As seen, the flanges 124 are, in effect, a continuation of the side surfaces 116. The ears 122 each have a hole 128 to receive a carabiner clip, or the like, to connect the attachment assembly to a lanyard. A small lip 132 having a forwardly sloping front surface is formed at the back of the top surface 118. A lower slot 134 extends rearwardly from the front surface 114. As seen in FIG. 9, the slot 134 does not extend all the way through the block 112, and thus is a blind slot. If desired, the slot 134 could extend through the block 112. Additionally, a hole 136 extends rearwardly from the front surface 114 of the body above the slot 134. The hole 136 does not extend all the way through the block 112. However, a threaded hole 137 extends forwardly from the back surface 114 of the body 112 to the hole 136.

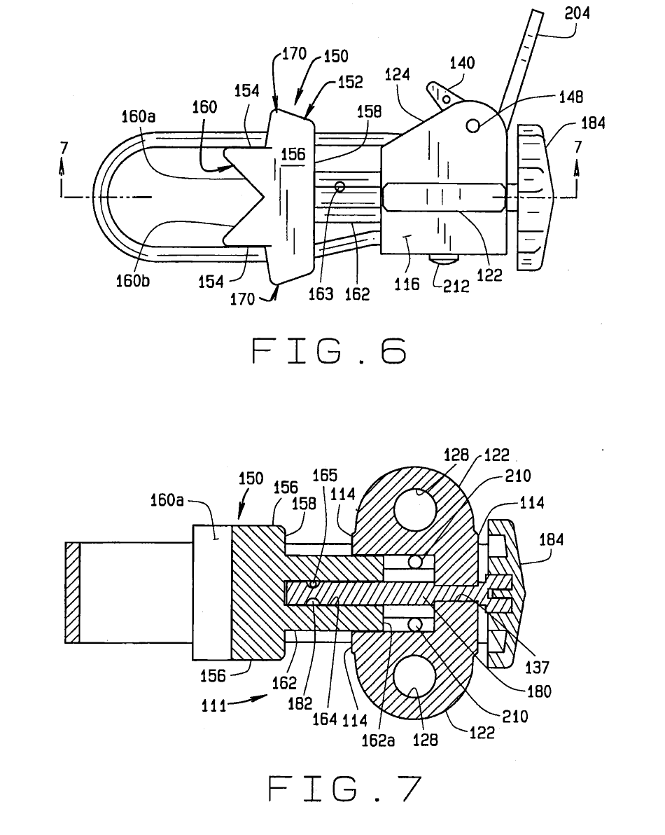

A lever 140 is mounted on the body between the flanges 124. The lever has sloping top and bottom surfaces 141 which expand apart from each other from a front of the lever to a rounded bottom or back end 142. The lever additionally has a flat surface 143 between the bottom surface 141 and the rounded back end 142. The back end 142 has elongate ridges or teeth 144 which extend across the width of the bottom end 142. A through hole 146 extends through the lever at the rounded bottom end 142. A pin 148 extends through the lever hole 146 and the holes 130 in the flanges 124. The pin 148 defines an axis around which the lever pivots. When the lever 140 is mounted between the body flanges 124, the lever bottom end 124 generally faces the sloped surface 132, and a small gap is formed between the bottom end of the lever and the sloped surface 132. The lever 140 is pivotal between a raised position (which is shown in FIGS. 6 and 9) and a lowered position. In the lowered position, the lever surface 143 is generally parallel to the sloped surface of the lip 132 on the surface 118 of the body 112. When the lever is pivoted to its lowered position, the size of the gap between the lever and the lip increases slightly.

A biasing element 147 is provided to bias the lever to its raised position. As best seen in FIG. 5, the lever 140 is provided with a second hole 147 near the front of the lever. The hole 149 can extend through the lever. The biasing element comprising a torsion spring having a lower leg 147a which rests against the body surface 118, a coil 147b through which the pin 148 extends, and a generally L-shaped arm 147c, the end of which extends into the hole 149 at the forward end of the lever 140. Although a torsion spring is disclosed to be used as the biasing element, the biasing element can be any element which will bias the lever to its raised position from its lowered position. Hence, the biasing element could also be an appropriately positioned coil spring or leaf spring, or even a foam member.

A shoe 150 includes a shoe body 152 having generally straight top and bottom surfaces 154, generally straight side surfaces 156, a back surface 158, and a generally V-shaped front surface 160. The front surface 160 is comprised of two inwardly sloping surfaces 160a,b which slope inwardly from the body side walls 152 and meet at the approximate center of the shoe body 152. The V-shaped front surface 160 receives the tool or other item to be connected to the lanyard when the attachment assembly 110 is in use. Although shown to be V-shaped, the tool receiving surface 160 could be curved, and the curve could be a constant curve (i.e., defining a single radius) or a progressive curve (which changes in radius along the curve).

A post 162 extends rearwardly from the body back surface 158. The post 162 has a back end 162a and a hole 164 extending forwardly from the post back surface 162a. A small transverse hole 163 extends across the post 162 and through the hole 164. The hole 163 is spaced rearwardly slightly from the back surface 158 of the shoe body 152 The post 162 is sized and shaped to be received in the hole 136 extending through the attachment assembly block 112. The post 162 and hole 136 are shaped complementarily to each other. Further, the post 162 and hole 136 are preferably shaped to prevent the shoe 150 from rotating relative to the attachment assembly block 112. To this end, the post 162 and hole 136 are each shaped to define a circle with ears extending from opposite sides of the circle. As can be appreciated, the post 162 could have almost any desired shape which will prevent rotating of the post 154 within the hole 136. For example, the post and hole could each define a regular (or irregular) polygon.

The shoe 150 additionally includes flanges 170 which extend outwardly from the shoe body walls 154. The flanges 170 each have a sloped outer surface 172 and a channel 174. The channel 174 is defined on an inner side by the tool body surface 154 on an outer side by a sloping wall 174a which is parallel to the flange outer wall 172. The channel is open at its front and at its back, the back opening defining a slot 176.

A threaded adjusting shaft 180 is passed forwardly through the threaded hole 137 and the hole 136 in the back surface of the attachment assembly body hole 136 to be received in the hole 164 of the shoe post 162. The adjusting shaft 180 has a circumferential groove 182 near its forward end and a handle or knob 184 at its back end. When the adjusting shaft is fully inserted in the post hole 164, the circumferential groove 182 is aligned with the transverse hole 163 in the shoe post 162. A locking pin 165 is inserted through the hole 163 and across the circumferential groove 182 to lock the adjusting shaft 180 relative to the shoe post 162. As can be appreciated, the pin 165 prevents the shaft 180 from moving axially relative to the shoe post 162, but allows for the shaft 180 to rotate relative to the shoe post. The shoe post 162 is not as deep as the body hole 136. Thus, rotation of the knob 184 in one direction will with draw the post into the hole 136, and thus draw the shoe 150 closer to the body 112. Conversely, rotation of the knob in the opposite direction will more the shoe 150 away from the body 112. As can be appreciated, as described, the shoe 150, shaft 180 and knob 184 move forward and backward relative to the body 112 as a unit. If desired, the post hole 164 could be threaded, and the shaft 180 could be fixed in place relative to the body 112 (rather than the shoe 150). This would achieve the same function, i.e., adjusting the position of the shoe 150 relative to the body 112.

Lastly, the tool attachment assembly includes a flexible rubber or rubber-like strap or band 200 having opposed ends 202 and 204. With reference to FIG. 9, the ends 202, 204 of the strap 200 are passed through the two channels 174 and through their respective slots 176 to form a loop 206 which extends forwardly of the shoe surface 160. The strap end 202 has a pair of holes 208 formed therein. A corresponding pair of holes 210 is formed in the bottom surface of the attachment assembly block 112. The holes 208 are sized and shaped to correspond to the size and shape of the holes 210 which open into the slot 134 in the attachment assembly block 112. The band end 202 is inserted into the slot 134, and a pair of screws 212 are screwed into the holes 210 in the attachment assembly body 212 and through the holes 208 in the band. The screws 210 thus hold the band 200 in the body. The opposite end 204 of the band 200 is threaded through the gap defined by the lever 140 and the lip 132 on the upper surface 118 of the attachment assembly block 112.

To assembly the attachment assembly 110, the band 200 can first be attached to the attachment assembly block 112, as just noted above, and the band end 204 can then be threaded through the shoe 150. The shoe 150 can then be locked to the attachment assembly block 112 using the locking shaft 180, and the band end 204 can then be threaded between the lever 150 and the attachment assembly lip 132. Alternatively, the band 200 can be threaded through the shoe 150, the band end 202 can be secured in the attachment assembly block 112, the shoe 150 can be secured to the block 112, and the band end 204 can be threaded between the lever 140 and the lip 132. The attachment assembly 110 can be assembled in any other way desired.

As noted above, the lever 240 pivots about the rod 148. When the lever is in a raised position, such as shown in FIG. 9, the gap between the lever and the lip 132 is reduced in size, and the ridges or teeth 144 of the lever engaging the band 200. In this position, the band 200 is fixed in place relative to the attachment assembly body 212. By pressing the lever forward (i.e., towards the attachment assembly body upper surface 118, the lever ridges or teeth 144 are disengaged from the band and the size of the gap between the lever and the lip is increased. The increase in the size of the gap allows for the band to be moved relative to the attachment assembly body 212, to increase or decrease the size of the band loop 206.

In use, position of the shoe 150 is initially adjusted such that the back surface 158 of the shoe is proximate the forward surface of the body 112. The lever will first be pressed down, to allow for the loop to be increased in size, if necessary, to enable the handle, shaft, shank, body etc. of a tool to be passed through the loop. With the tool in place relative to the loop, and with the lever in a lowered position, the end 204 of the band 200 is pulled to reduce the size of the loop, to securely grip the tool between the band 200 and the shoe surface 260. When the band is tight, the lever 140 is pulled up to secure the band in place, thereby securing the tool in the attachment assembly 110. With the band manually tightened, the adjusting shaft is rotated to move the shoe 150 away from the body 112. As can be appreciated, the band 200 is secured in place relative to the body 112. Thus, the movement of the shoe 150 away from the body 112 will further tighten the band 200 around the tool, to even more securely grip the tool between the shoe and the band. To release the tool from the attachment assembly, the lever 200 is simply pressed to its lowered position. In this position, the gap defined by the lip and the sloped back surface 144 of the lever is slightly wider than the width of the band, and the band can be loosened relative to the tool, thereby allowing the tool to be removed from the attachment assembly 110.

As can be appreciated, the tool receiving surface 160 has a certain depth. Hence, to securely hold a tool, the portion of the tool received in the surface 160 must have a width that is at least slightly greater than the depth of the surface 160.

The two attachment assemblies 10, 110 operate oppositely relative to each other. In attachment assembly 10, the body (which has the tool receiving surface or edge) is stationary and the bracket (to which the band is connected) is movable. In this embodiment, the band is tightened around the tool by moving the bracket rearwardly (i.e., in a pulling motion) to pull the bracket into the body 12 or closer to the closed end of the body 12. In the attachment assembly 110, on the other hand, the body 112 (to which the band is secured) is stationary and the shoe (which ahs the tool receiving surface) is movable, In this embodiment, the band is tightened around the tool by moving the shoe forwardly (i.e., by pushing) to push the shoe away from the body.

It will be understood from the drawings and the description above, that the attachment assemblies 10, 110 are simple to operate, and can be operated without the use of tools. Further, the attachment assemblies 10, 110 can receive tools of varying sizes. Hence, each attachment assembly can be used to secure varying sized tools to a lanyard. In both attachment assemblies, the bands are easily replaced when or if the bands become damaged.

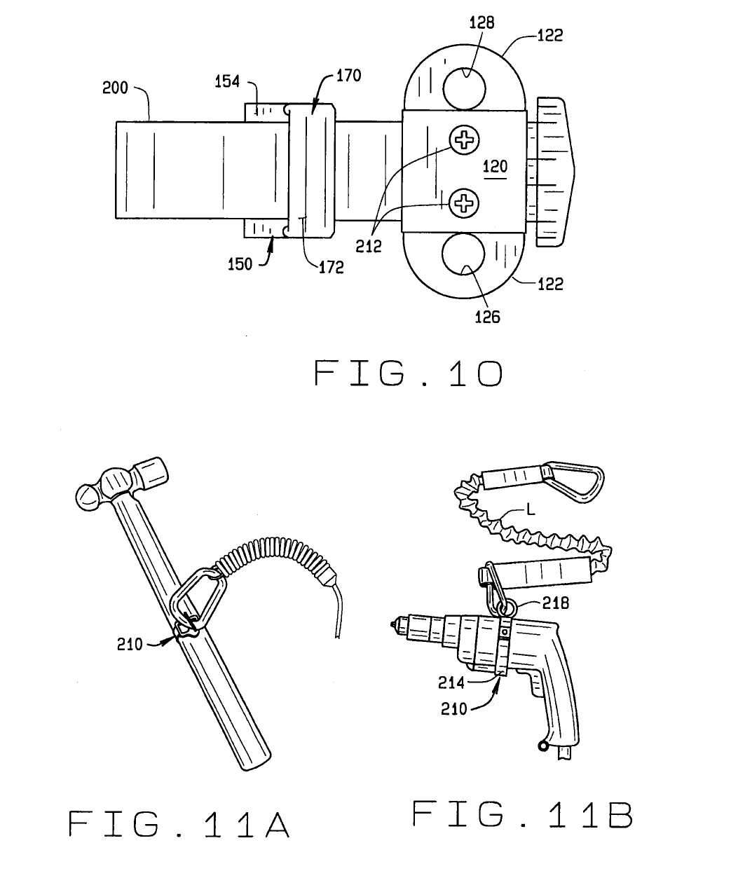

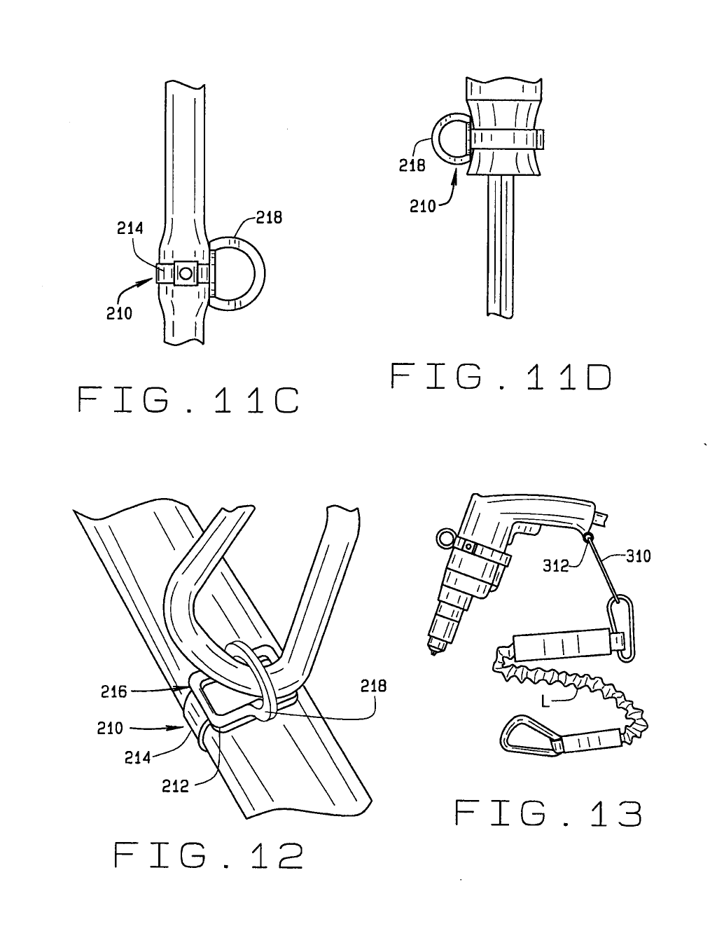

A third attachment assembly 210 or connector is shown generally in FIGS. 11A-D mounted to a hammer shaft (FIG. 11A), a drill body (FIG. 11B), a ratchet (FIG. 11C) and a screw driver (FIG. 11D). The attachment assembly 210 is shown in more detail in FIG. 12. The attachment assembly 210 comprises a ring member 212 and a strap or band 214. The ring member 212 comprises a base portion 216 which is shown to be generally rectangular in plan. The base portion thus includes two opposed short sides and two opposed long sides. A divider which is generally parallel to the opposed short sides extends between the opposed long sides such that the base portion defines two discrete open areas which are about equal in size. A D-ring 218 extends from the divider upwardly out of the plane of the base portion 216. The D-ring comprises two legs which extend from the base portion at opposite ends of the divider and a connecting section which extends between the upper ends of the legs. The divider, and the D-ring legs and connector in combination, define a closed shape or ring which receives a clip, such as a carabiner clip, as shown in the drawings. The strap 214 is threaded through the base portion and extends around the tool to secure the ring member 212 to the tool. As shown, the strap extends over the divider and under the two opposed short sides of the ring member base portion 216. However, the strap could extend over the two short sides and under the divider. The strap 214 is a flexible or bendable strap which, as noted, surrounds the tool, and can conform generally to the shape of the surface of the tool. The strap or band is fixed to itself, for example, by means of a rivet, and is thus not adjustable relative to the tool. The attachment assembly thus is fixed to the tool, and unlike the attachment assemblies 10 and 110, stays with the tool.

Lastly, FIG. 13 shows a fourth attachment assembly 310. Some tools either have a hole 312 or a hole can be formed in the tool. For example, in the drill shown in FIG. 13, a ring or hole 312 is shown at the end of the drill handle. Additionally, a hole could be formed, for example, at the end of the wooden shaft of the hammer of FIG. 11A. The attachment assembly comprises a band or strap which forms a loop that passes through the hole 312. The carabiner clip of the lanyard can then receive this loop. In this embodiment, the band or strap can be formed from a relative short length of steel rope, or other cord-type product which can withstand the forces imposed by a drop and which does not lengthen substantially when tensioned.

It will be appreciated by those skilled in the art that the foregoing written description, representative embodiments and accompanying drawings are intended to be illustrative of the general concept of the invention and should not be construed to limit the claims in any manner. Although the attachment assemblies 10, 110 rely on threaded shafts to tighten the hold of the attachment assembly to the tool, the adjusting of the position of the bracket 40 of the attachment assembly 10 or the shoe 150 of the attachment assembly 110 can be achieved by other means. For example, the adjustment of the position of the bracket 40 or the shoe 150 relative to the bodies 12, 112 respectively, could be achieved by a ratcheting mechanism. This example is merely illustrative.

1. An attachment assembly for securing an object to a lanyard, the attachment assembly comprising:
a body having a side surface, a first tool receiving end, a send closed end opposite said tool receiving end; said body being hollow;
a bracket received within said body, and being movable axially relative to said body;
a threaded adjusting shaft extending through said closed end of said body and engaging said bracket; whereby rotation of said adjustment mechanism in a first direction moves said bracket closer to said end wall and rotation of said adjustment mechanism in an opposite direction moves said bracket farther from said end wall;
a flexible band opposed ends and a mid-section; said band being secured to said bracket proximate its opposed ends; said band mid section extending from said tool receiving end of said body to define a loop; and
an attachment point for securing said attachment assembly to a lanyard.

2. The attachment assembly of claim 1 wherein said tool receiving end comprises at least one contoured section of said tool receiving end.

3. The attachment assembly of claim 2 wherein said tool receiving end comprises a first contour and a second contour, said first and second contours being differently shaped; said first contour defining a generally curved surface and said second contour defining a generally V-shaped notch.

4. The attachment mechanism of claim 1 wherein said bracket comprises an end wall and a pair of opposed arms extending forwardly from said end wall; said arms each comprising a pair of generally parallel slots; said band being threaded through the slots to secure said band to said bracket.

5. The attachment assembly of claim 4 wherein said bracket is sized relative to said body such that a gap is formed between outer surfaces of said bracket arms and an inner surface of said body; said band being threaded through said bracket arms slots, such that band extends along at least a portion of the outer surface of said bracket arms; said band having a width approximately equal to the width of said gap, such that a frictional engagement exists between said band and said body inner wall and between said band and said bracket arm.

6. The attachment assembly of claim 4 including a pair of spaced apart pins extending across said body; said pins being generally parallel to the bracket arms and spaced inwardly from the bracket arms; said band extending across inner surfaces of said pins, such that said loop has a generally tear-shaped appearance.

7. The attachment assembly of claim 6 wherein said pins are defined by arms of a U-bolt; said U-bolt defining the point of attachment.

8. An attachment assembly for securing an object to a lanyard, the attachment assembly comprising:
a body having side surfaces, an upper surface, a back surface, a bottom surface, and a front surface;
a lever pivotally mounted on said body; said lever having an enlarged and movable between a raised position and a generally rounded bottom end with ridges extending at least partially across said bottom end; said lever being mounted to said body to define a gap between said lever and said body top surface; said lever being movable between a locking position in which said ridges generally face said body top surface and a releasing position in which said ridges do not generally face said body top surface; said lever being shaped such that said gap between said lever and said body top surface is smaller when said lever is in said raised position than when said lever is in said lowered position;
a biasing member to normally bias said lever to the lever's locking position;
a shoe having a forwardly facing tool receiving surface; said shoe being mounted to said body to be movable relative to said body;
a flexible band having opposed ends and a mid-section; said band being secured to said body at a first of said opposed ends; said second of said opposed ends being threaded through said gap, such that said band defines a loop forwardly of said tool receiving surface of said shoe; and
an attachment point for securing said attachment assembly to a lanyard.

9. The attachment assembly of claim 8 including at least one ear extending from said body; said ear defining said attachment point.

10. The attachment assembly of claim 8 including a threaded adjustment shaft which extends through said body to be received in said shoe; whereby rotation of said adjustment shaft in a first direction moves said shoe closer to said body front surface and rotation of said adjustment shaft in a second direction moves said shoe away from said body front surface.

11. The attachment assembly of claim 10 wherein said adjustment shaft is axially fixed relative to said shoe, said body including a threaded opening through which said shaft extends.

12. The attachment assembly of claim 8 wherein said shoe comprises a pair of opposed slots on opposite sides of said tool receiving surface; said band being threaded through said slots of said shoe.

13. An attachment assembly for securing an object to a lanyard, the attachment assembly comprising:
a stationary member and a movable member; said movable member being movable relative to said stationary member; one of said stationary and movable members defining an object receiving surface;
a band having opposed ends and a mid-section; said opposed ends each being secured either said movable member or said stationary member;
an adjusting member for adjusting the position of said movable member relative to said stationary member.

14. The attachment assembly of claim 13 wherein said tool receiving surface is on a forward surface of said stationary member and said band is secured to said movable member.

15. The attachment assembly of claim 13 wherein said tool receiving surface is on a forward surface of said movable member and said band is secured to said stationary member.

16. The attachment assembly of claim 15 comprising a lever on said stationary member; said lever defining a gap with said stationary member and being movable between a locking position and a releasing position; one end of said band being threaded through said gap; whereby, the size of said loop defined by said band is selectively adjustable.

17. The attachment assembly of claim 13 wherein the lanyard is an energy absorbing lanyard.
